(19) United States
(12) Patent Application Publication
(10) Pub. No.: US 2006/0204825 A1
(43) Pub. Date: Sep. 14, 2006

(54) Current collector plate for an electrochemical cell stack

(75) Inventors: Antonio Gennaro Mazza, Whitby (CA); Chen-Chung Steve Chang, Attleboro, MA (US); Michael David Hardy, Cumberland, RI (US); Robert Weiermair, Marina Del Ray, CA (US)

Correspondence Address: VINSON & ELKINS, L.L.P., 1001 FANNIN STREET, 2300 FIRST CITY TOWER, HOUSTON, TX, 77002-6760, US

(73) Assignees: Hydrogenics Corporation, Mississauga (CA); Engineered Materials Solutions, Inc., Attleboro, MA (US)

(21) Appl. No.: 11/075,126

(22) Filed: Mar. 8, 2005

(51) Int. Cl. H01M 8/02; B05D 5/12

(52) U.S. Cl. 429/38; 427/115

(57) ABSTRACT

A current collector plate for an electrochemical cell stack is described. The plate includes a corrosion resistant substrate having a recess in a central region of the inner face. Passageways in the substrate terminate at openings on the inner face to allow process fluids to pass through the plate. An electrically conductive coating is disposed in the recess for collecting current.

### FIELD OF THE INVENTION

The present invention relates to end assemblies for an electrochemical cell stack, and more specifically to current collector plates therefor.

### BACKGROUND OF THE INVENTION

Electrochemical cell stacks include fuel and electrolytic cell stacks. A fuel cell is an electrochemical device that produces an electromotive force by bringing a fuel (typically hydrogen gas) and an oxidant (typically air or oxygen gas) into contact with two suitable electrodes and an electrolyte. The fuel is introduced at a first electrode where it reacts electrochemically in the presence of the electrolyte to produce electrons and cations. The electrons are circulated from the first electrode to a second electrode via an electrical circuit. Cations pass through the electrolyte to the second electrode.

Simultaneously, the oxidant is introduced to the second electrode where the oxidant reacts electrochemically in presence of the electrolyte and catalyst, producing anions and consuming the electrons circulated through the electrical circuit; the cations are consumed at the second electrode. The anions formed at the second electrode or cathode react with the cations to form a reaction product. The first electrode or anode may alternatively be referred to as a fuel or oxidizing electrode, and the second electrode may alternatively be referred to as an oxidant or reducing electrode.

The half-cell reactions at the two electrodes are, respectively, as follows:
H2→2H++2e−
½O2+2H++2e−→H2O

The external electrical circuit withdraws electrical current and thus receives electrical power from the fuel cell. The overall fuel cell reaction produces electrical energy as shown by the sum of the separate half-cell reactions written above. Water and heat are typical by-products of the reaction.

Conceptually, electrolytic cells are fuel cells that are run in reverse, and share many of the same components as fuel stacks. In particular, a current is supplied to the electrolytic cell stack for the electrolysis of water into hydrogen and oxygen gases. In a fuel cell, hydrogen and oxygen are combined to produce water and release heat. In an electrolytic cell stack, energy is required to break up water into hydrogen and oxygen.

In practice, fuel cells are not operated as single units. Rather, fuel cells are connected in series, stacked one on top of the other, or placed side by side, to form what is usually referred to as a fuel cell stack. As used herein, the term “cell stack” includes the special case where just one fuel cell is present, although typically a plurality of fuel cells are stacked together to form a cell stack. The fuel and oxidant are directed through manifolds to the electrodes, while cooling is provided either by the reactants or by a cooling medium. Also within the stack are current collectors, cell-to-cell seals and insulation, with required piping and instrumentation provided externally of the fuel cell stack.

A fuel cell stack includes two end plates that sandwich components of the fuel cell stack. End plates provide integrity to the fuel cell stack by acting as an anchor for rods or bolts that are used to compress together various components of the cell stack resting between the end plates. Moreover, end plates can contain connection ports to which are attached fuel, oxidant and coolant ducts or hoses. These process fluids flow through the connection ports into and out of the fuel cells stack. In addition, end plates have components that insulate electrically conductive parts from parts meant to be non-conductive.

If components of the end assembly are not sufficiently protected from corrosive chemicals, several problems can arise. Particles, dissolved ions and/or flakes of the corroded material may be entrained by the process fluids and travel to components within the fuel cell. There, these particles and flakes can cause degradation or malfunction of the fuel cell stack. Also, corrosion of the portions of the current collector plates that are in electrical contact with other components of the fuel cell stack can result in those portions exhibiting a higher electrical resistance, which can lead to less than ideal performance. Finally, corrosion can compromise the structural integrity of the fuel stack, potentially leading to many modes of malfunction or ultimate collapse of the fuel cell stack structure.

Consequently, any innovation that improves the anti-corrosive properties of components of an end assembly, while keeping the overall volume and weight of the end assembly manageable, would be desirable in the field of electrochemical cell stacks.

### SUMMARY OF THE INVENTION

Described herein is a current collector plate for an electrochemical cell stack that at once has good current collecting abilities and corrosion-resistant properties. The current collector plate includes a corrosion resistant substrate having an outer face facing away from the cell stack and an inner face opposite the outer face. The substrate includes a recess in a central region of the inner face. Passageways in the substrate terminate at openings on the inner face to allow process fluids to pass through the plate. The openings lie outside of the central region. An electrically conductive coating is disposed in the recess for collecting current.

### BRIEF DESCRIPTION OF THE DRAWINGS

For a better understanding of the present invention, and to show more clearly how it may be embodied, reference will now be made, by way of example, to the accompanying drawings, which show preferred embodiments of the present invention and in which:

FIG. 1 shows an exploded perspective view of an electrochemical cell stack;

FIGS. 2A and 2B show a plan view and a cross-sectional view of a current collector plate, according to the teachings of the present invention; and

FIG. 3 shows a composite block for forming the current collector plate of FIGS. 2A and 2B, according to the teachings of the present invention.

### DETAILED DESCRIPTION OF THE INVENTION

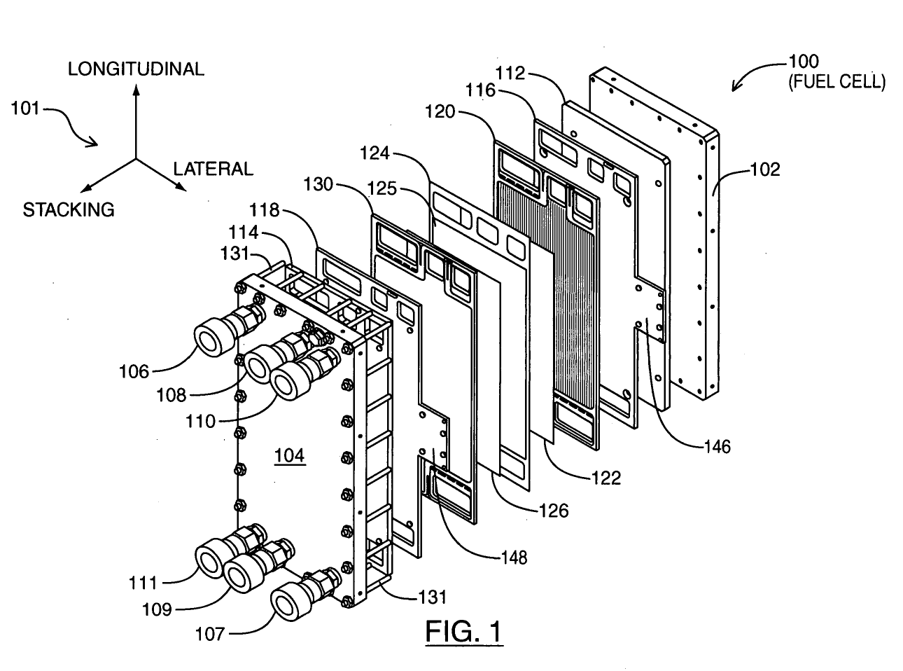

FIG. 1 shows an exploded perspective view of an electrochemical cell stack 100. A coordinate system 101, with stacking, longitudinal and lateral directions marked, is provided for convenient referencing. The fuel cell unit 100 includes an anode flow field plate 120, a cathode flow field plate 130 that sandwich a membrane electrode assembly (MEA) 124. Various sizes are possible for the plates 120 and 130. In one embodiment, for example, the short edge of the flow field plates 120, 130 is about 12 cm. Each plate 120 and 130 has an inlet region, an outlet region, and open-faced channels (not shown). The channels fluidly connect the inlet region to the outlet region, and provide a way for distributing the reactant gases to the outer surfaces of the MEA 124.

The MEA 124 comprises a solid electrolyte (i.e. a proton exchange membrane or PEM) 125 disposed between an anode catalyst layer (not shown) and a cathode catalyst layer (not shown). A first gas diffusion layer (GDL) 122 is disposed between the anode catalyst layer and the anode flow field plate 120, and a second GDL 126 is disposed between the cathode catalyst layer and the cathode flow field plate 130. The GDLs 122, 126 facilitate the diffusion of the reactant gas, either the fuel or oxidant, to the catalyst surfaces of the MEA 124. Furthermore, the GDLs enhance the electrical conductivity between each of the anode and cathode flow field plates 120, 130 and the membrane 125.

A first current collector plate 116 abuts against the rear face of the anode flow field plate 120, where the term “rear” indicates the side facing away from the MEA 124. Likewise, the term “front” refers to the side facing the MEA. A second current collector plate 118 abuts against the rear face of the cathode flow field plate 130. Each of the first and second current collector plates 116 and 118 respectively has a tab 146 and 148 protruding from the side of the fuel cell stack. First and second insulator plates 112 and 114 are located immediately adjacent the first and second current collector plates 116, 118, respectively. First and second end plates 102, 104 are located immediately adjacent the first and second insulator plates 112, 114, respectively. Pressure may be applied on the end plates 102, 104 to press the unit 100 together. Moreover, sealing means are usually provided between each pair of adjacent plates. Preferably, a plurality of tie rods 131 may also be provided. The tie rods 131 are screwed into threaded bores in the anode endplate 102, and pass through corresponding plain bores in the cathode endplate 104. Alternatively, the tie rods may pass through the anode end plate and be fastened by means of nuts and washers on the anode outside of the end plate. Fastening means, such as nuts, bolts, washers and the like are provided for clamping together the fuel cell unit 100.

The end plate 104 is provided with a plurality of connection ports for the supply of various fluids. Specifically, the second endplate 104 has first and a second air connection ports 106, 107, first and second coolant connection ports 108, 109, and first and second hydrogen connection ports 110, 111. The MEA 124, the anode and cathode flow field plates 120, 130, the first and second current collector plates 116, 118, the first and second insulator plates 112, 114, and the first and/or second end plates 102, 104 have three inlets near one end and three outlets near the opposite end, which are in alignment to form fluid ducts for air as an oxidant, hydrogen as a fuel, and a coolant. Also, it is not essential that all the outlets be located at one end, i.e., pairs of flows could be counter current as opposed to flowing in the same direction. In addition, it is not necessary that the current collector 116 include ports for fluid flow. The inlet and outlet regions of each plate are also referred to as manifold areas. Although not shown, it will be understood that the various ports 106-111 are fluidly connected to ducts that extend along the stacking direction of the fuel cell unit 100.

In the fuel cell stack shown in FIG. 1, the fuel cell stack runs in “closed-end” mode, which means process fluids and coolant are supplied to and discharged from same end of the fuel cell stack. It should be understood that in other versions, the fuel cell may run in “flow-through” mode where process fluids and coolant enter the fuel cell stack from one end and leave the stack from the opposite end thereof. This requires the first end plate 102 be provided with corresponding connection ports for process fluids. It should also be understood that in practice it is useful to stack the several plates 130, 120 and MEAs 124 to form a fuel cell stack to produce a greater current output. Cell stacks may have more than one hundred MEAs 124. It should be understood that instead of the “open ended” operation implied by FIG. 1, the principles of the present invention can also be applied to closed ended operation, where there is no flowthrough of the reactant gases.

End assemblies of conventional fuel cells, which include the end plates 102, 104, the insulator plates 112, 114 and the current collector plates 116, 118, suffer from several limitations that can give rise to corrosion and short circuits. In particular, process fluids can corrode the parts of the end assembly that come into contact with these fluids, notably, the fluid ducts that extend along the length of the fuel cell unit 100, and which allow the fluids to pass therethrough.

Corrosion can lead to several problems. Particles, dissolved solids or flakes of the corroded material may be entrained by the process fluids and travel to components within the fuel cell, such as the flow field plates 120 and 130. There, these particles, dissolved solids and flakes can cause degradation or malfunction of the fuel cell stack. Also, corrosion of the portions of the current collector plates that are in electrical contact with other components of the fuel cell stack can result in those portions exhibiting a higher electrical resistance, which can lead to less than ideal performance. Finally, corrosion can compromise the structural integrity of the fuel stack, potentially leading to collapse due to loss of structural integrity of the affected stack components.

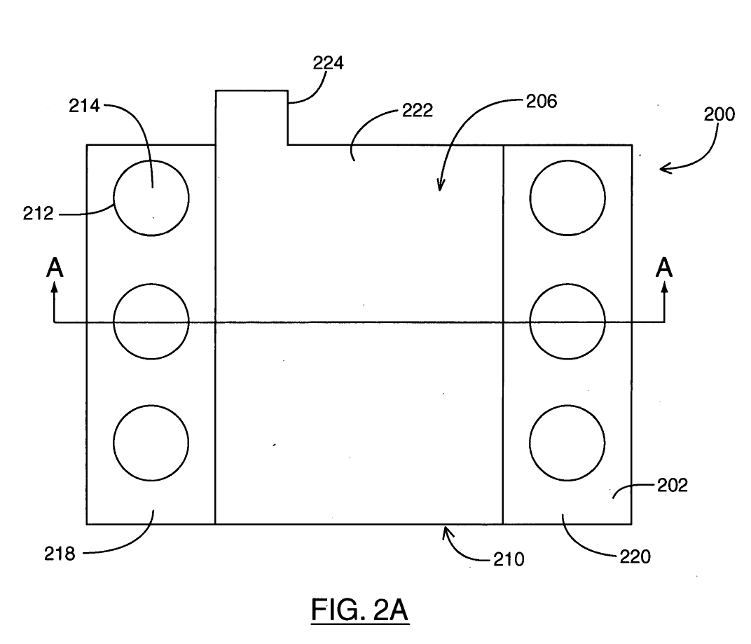

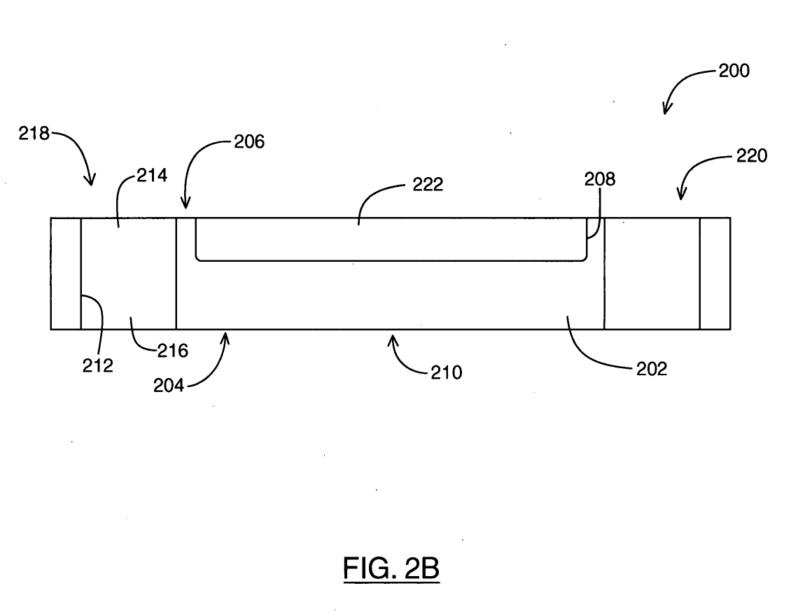

FIGS. 2A and 2B show a plan view and a cross-sectional view (through A-A) of a current collector plate 200 for an electrochemical cell stack that addresses some of the above-mentioned drawbacks of conventional fuel cells. The current collector plate 200 includes a corrosion resistant substrate 202 having an outer face 204 facing away from the cell stack and an inner face 206 opposite the outer face 204. The faces 204, 206 are preferably flat and parallel with one another. The substrate 202 includes a recess 208 in a region 210, such as a central region, of the inner face 206. The recess 208 extends in the lateral direction to the edges of the substrate 202. In other embodiments, the recess 208 does not extend to the edges, the substrate 202 instead “framing” the recess 208.

Passageways 212 in the substrate 202 extend in the stacking direction from openings 214 on the inner face 206 to openings 216 on the outer face 204. The openings 214 and 216 lie outside of the central region 210. In the embodiment shown, the passageways 212 number six with three lying along a lateral direction to one side 218 of the central region 210 and three lying along the lateral direction on an opposite side 220. The passageways 212 allow process fluids (fuel, oxidant and coolant) to pass through the plate 200.

The current collector plate 200 also includes an electrically conductive coating 222 inlayed in the recess 208 for collecting current. The electrically conductive coating 222 is disposed so as to avoid the process fluids. In a preferred embodiment, the coating 222 is flush with the portion of the inner face of the substrate that excludes the region 210. In other embodiments, this need not be the case.

The substrate 202 includes a tab 224 coated with the electrically conductive coating 222. The tab 224 allows electrical leads (not shown) to be connected to the plate 200 to collect current. In one embodiment, the thicknesses of the substrate 202 and the coating 222 comprising the tab 224 are the same as in the rest of the plate 200.

For a typical fuel cell stack intended to produce 500 amperes, the dimension of the substrate along a longitudinal direction is approximately 40 cm, along a lateral direction approximately 19 cm, along a stacking direction at the central region approximately 0.99 mm, and along the stacking direction at the one side and at the opposite side approximately 1.00 mm. Thus, the recess in this example is approximately 0.01 mm deep. It should be understood that these dimensions are exemplary only, and that other dimensions could be used depending on the particular application.

The corrosion resistant substrate 202 comprises a valve metal. As used herein, the term “valve metal” refers to metals that form a thin, protective, self-healing oxide film tightly adhered to the surface thereof. Valve metals resist the passage of current in the anodic direction. Thus, any attempt to use a valve metal as an anode requires the potential of the valve metal surface to be raised to a value that is higher than the breakdown potential of the surface oxide film. Only then, can significant current pass through the anode. This resistance to electrical conduction promotes anti-corrosive properties of the substrate because corrosion of metals is, as well known to those knowledgeable in the art, an electrochemical process.

For example, the corrosion resistant substrate 202 can comprise at least one of titanium, niobium, tungsten, tantalum, aluminum, stainless steel, nickel, chromium, copper, molybdenum, iron, Inconel™, Monel™, Hastelloy™, and alloys thereof that may be commercially available, proprietary or developmental alloys.

The electrically conductive coating 222 can comprise at least one of copper, silver, gold, nickel and aluminum, or commercially available, proprietary or developmental alloys that possess electrically conductive surface properties

The combination of substrate 202 in contact with the coating 222 forms a galvanic couple. When the substrate 202 is composed of titanium and the coating 222 is composed of copper, for example, the substrate 202 becomes anodically polarized by the electrically conductive coating 222 because copper is a nobler metal in the electrochemical series. Such contact with copper promotes the formation of a passivation layer (i.e., a thin anodic valve metal oxide film described above) on the titanium substrate. 202. Because the passivation layer reduces electrical conductivity, the surface of the substrate 202 is less prone to corrosion. In addition, the passive layer also serves to act as a means of electrical isolation between the process fluids and the substrate at the manifold areas, leading to reductions of parasitic shunt currents through the manifold ports of the electrochemical stacks.

Although a recess 208 is shown in FIG. 1 for inlaying the coating 222, it should be understood that in other embodiments, the recess can be absent. With or without a recess, the coating can be explosion clad, rolled, braced, welded, electroplated, electroless plated, clad or powder metallurgically disposed on the substrate.

In operation, the electrically conductive coating 222 is in electrical communication with a flow field plate (not shown in FIGS. 2A and 2B) from which current is drawn. In one embodiment, the copper coating 222 is in direct contact with the flow field plate. The titanium substrate 202 is in contact with the process fluids, whereas the copper coating 222 avoids these fluids. Advantageously, the combination of a titanium substrate 202 and a copper coating 222 results in a current collector plate that is both resistant to corrosion where corrosion is most likely to occur (near and in the passageways), and conductive where current needs to be drawn from the flow field plate by the electrically conductive coating 222.

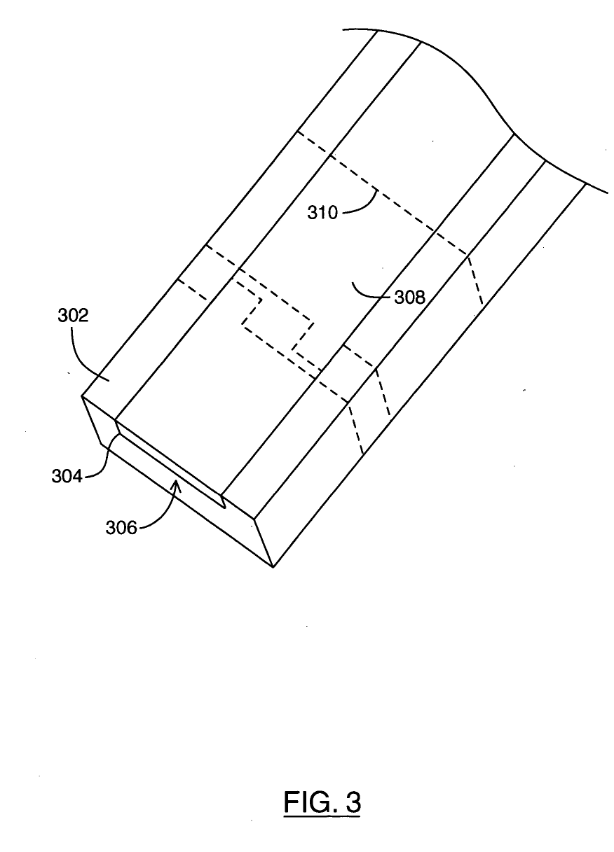

FIG. 3 shows a block 300 for forming the current collector plate 200 of FIGS. 2A and 2B. The block 300 includes a corrosion resistant substrate 302 having a recess 304 in a central region 306. An electrically conductive coating 308 is inlayed in the recess 304. The coating 308 can be inlayed in the substrate 302 in a number of ways. It will be appreciated that the block 300 has a substantially constant cross-section, which give a number of options for forming the block 300, including extrusion techniques. For example, the substrate 302 can first be skived to form the recess 304. Instead or in addition, the electrically conducting coating 308 is explosion clad, rolled, braced, welded, electroplated, electroless plated, clad or powder metallurgically disposed on the substrate 302. Edges may be reamed. The block 300, which contains the substrate 302 with the recess 304 inlayed with the electrically conducting coating 308, may be used to form the current collector plate 200. The dashed lines 310 demark where the block 300 can be cut to form current collector plates 200. The passageways 212 (not shown in FIG. 3) can be formed by drilling, stamping or cutting, for example. Instead, the block 300, together with the passageways, can be formed by various molding techniques.

The present invention is not limited to the embodiments shown or described above. For example, the terminal plate can be circular, oval and other shapes, with the coating correspondingly having a variety of shapes. Moreover, the shape of the opening 214 and 216 can vary. It is also to be understood that the present invention is not only applicable to current collector plates for fuel cell stacks, but is also applicable to current collector plates for other electrochemical cells, such as an electrolyzer. In addition, although reference was made to a PEM fuel cell stack of FIG. 1, the principles of the present invention can be applied to other fuel cell types. Also, the electrolyzers and fuel cells that fall under the purview of the present invention do not necessarily require intermediate cooling, which can therefore reduce the number of connection ports.

It is anticipated that those having ordinary skills in the art can make various modifications to the embodiments disclosed herein after learning the teaching of the present invention. For example, the number and arrangement of components in the system might be different, and different elements might be used to achieve the same specific function. However, these modifications should be considered to fall under the scope of the invention as defined in the following claims.

1. A current collector plate for an electrochemical cell stack, the current collector plate comprising
a) a corrosion resistant substrate having an inner face for abutting elements of the electrochemical cell stack, and including a recess in a region of the inner face;
b) passageways in the substrate that terminate at openings on the inner face to allow process fluids to pass through the plate, the openings lying outside of the region; and
c) an electrically conductive coating disposed in the recess for collecting current.

2. The plate of claim 1, wherein the corrosion resistant substrate comprises a valve metal.

3. The plate of claim 1, wherein the corrosion resistant substrate comprises at least one of titanium, niobium, tungsten, tantalum, aluminum, stainless steel, Inconel™, Monel™, Hastelloy™, and alloys thereof.

4. The plate of claim 1, wherein, in a lateral direction, the recess extends to the edges of the substrate, and the plate has a substantially constant cross-section.

5. The end assembly of claim 1, including an outer face, wherein the outer face and the inner face are substantially rectangular, and are substantially flat and parallel with one another.

6. The plate of claim 5, wherein the passageways extend in a stacking direction from the openings on the inner face to openings on the outer face.

7. The plate of claim 6, wherein the passageways number six with three lying along a lateral direction to one side of the region and three lying along the lateral direction on an opposite side.

8. The plate of claim 7, wherein the dimension of the substrate along a longitudinal direction is about 40 cm, along a lateral direction about 19 cm, along a stacking direction at the region about 0.99 mm, and along the stacking direction at the one side and at the opposite side about 1.00 mm.

9. The plate of claim 1, wherein the recess is from about 0.001 mm to about 0.01 mm deep.

10. The plate of claim 1, wherein the electrically conductive coating comprises at least one of copper, silver, gold, nickel and aluminum.

11. The plate of claim 1, wherein the electrically conductive coating is disposed so as to avoid the process fluids.

12. The plate of claim 1, wherein the substrate and the coating form a galvanic couple.

13. The plate of claim 12, wherein the substrate is anodically polarized by the electrically conductive coating.

14. The plate of claim 1, wherein the substrate includes a passivation layer on the surface thereof.

15. The plate of claim 1, wherein the substrate includes a tab coated with the electrically conductive coating.

16. An electrochemical cell stack comprising a flow field plate assembly including
a) an anode flow field plate;
b) a cathode flow field plate; and
c) a membrane electrode assembly disposed between the anode and cathode field plates for producing current; and
d) an end assembly on opposite sides of the flow field plate assembly, the end assembly including an insulator plate comprising
i) a corrosion resistant substrate having an inner face for abutting elements of the electrochemical cell stack, and including a recess in a region of the inner face;
ii) passageways in the substrate that terminate at openings on the inner face to allow process fluids to pass through the plate, the openings lying outside of the region; and
iii) an electrically conductive coating disposed in the recess for collecting current.

17. The plate of claim 16, wherein the corrosion resistant substrate comprises a valve metal.

18. The plate of claim 16, wherein the corrosion resistant substrate comprises at least one of titanium, niobium, tungsten, tantalum, aluminum, stainless steel, Inconel™, Monel™, Hastelloy™, and alloys thereof.

19. The plate of claim 16, wherein the electrically conductive coating comprises at least one of copper, silver, gold, nickel and aluminum.

20. A method for fabricating a current collector plate for an electrochemical cell stack, the method comprising
a) providing a corrosion resistant substrate an inner face for abutting elements of an electrochemical cell stack;
b) forming a recess in a region of the inner face;
c) providing passageways in the substrate that terminate at openings on the inner face to allow process fluids to pass through the plate, the openings lying outside of said region; and
d) providing an electrically conductive coating in the recess for collecting current.

21. The method of claim 20, including forming the corrosion resistant substrate from at least one of titanium, niobium, tungsten, tantalum, aluminum, stainless steel, Inconel™, Monel™, Hastelloy™, and alloys thereof.

22. The method of claim 20, including forming the electrically conductive coating from at least one of copper, silver, gold, nickel, aluminum.

23. The method of claim 20, wherein the step of forming a recess includes skiving the region of the inner face.

24. The method of claim 20, wherein the step of providing the electrically conductive coating includes at least one of inlaying, rolling, explosion cladding, bracing, welding, electroplating, electroless plating, cladding and powder metallurgically disposing the electrically conductive coating on the substrate.

25. A current collector plate for an electrochemical cell stack, the current collector plate comprising
a) a substrate having an inner face;
b) an electrically conductive coating disposed on a region of the inner face for collecting current; and
c) passageways in the substrate that terminate at openings on the inner face to allow process fluids to pass through the plate.

26. The current collector plate of claim 25, wherein the openings lie outside of the region.
